(19) United States
(12) Patent Application Publication
(10) Pub. No.: US 2003/0049397 A1
(43) Pub. Date: Mar. 13, 2003

(54) Protective nonwoven web for sensitive surfaces

(75) Inventors: Irwin Jerold Singer, Lawrenceville, GA (US); Richard John Schmidt, Roswell, GA (US); Charles Edward Bolian II, Buford, GA (US)

Correspondence Address: Ralph H, Dean, Jr,, Kimberly-Clark Worldwide, Inc., Patent Department, 401 North Lake Street, Neenah, WI, 54956, US

(73) Assignee: Kimberly-Clark Worldwide, Inc.

(21) Appl. No.: 09/954,874

(22) Filed: Sep. 12, 2001

(51) Int. Cl. B32B 1/02

(52) U.S. Cl. 428/36.2; 428/36.1

(57) ABSTRACT

A protective nonwoven fabric having a bulk density in the range of about 0.075 g/cc to about 0.130 g/cc and a Gurley stiffness greater than about 80 mg has been discovered to be effective in protecting articles with sensitive surfaces from damage caused by dirt, dust and/or other particulate contaminants. The sensitive surface protective material of the present invention has the ability to capture and entrap dirt, dust and other particulate contaminants and prevent the redepositing of these contaminants onto the sensitive surfaces. The material is disclosed as being useful for preparing sleeves for holding and storing articles with sensitive surfaces, for example, compact disc.

### FIELD OF THE INVENTION

The present invention generally relates to using a nonwoven web to protect sensitive surfaces of articles having a surface susceptible to scratches or damage caused by particles, such as, dust, dirt and other particulate contaminants. More particularly, the nonwoven web used in the present invention has a low bulk density, a specified stiffness and voids which enables the nonwoven web to entrap particles, such as dust and dirt, which may cause scratches to the sensitive surface.

### BACKGROUND OF THE INVENTION

Often, articles with sensitive surfaces that are susceptible to damage or contamination with dust, dirt, or other particulate contaminants, such as compact disc, collectible coins, collectible stamps, phonograph records, overhead transparencies, lithographic plates, precision machine parts, polished metals, glass, glass substitutes, such as polycarbonate and polymethacrylates and the like, are usually protected from damage by protective covers, protective wraps or protective surfaces attached to the sensitive surface.

Many methods have been proposed in the art to protect items with sensitive surfaces from damage during storage. For example, paper sleeves were used to protect phonograph records, which are audio recordings before the invention of the compact disc. In a similar fashion, photographic transparencies, which are often used with an overhead projector, are often protected by inserting a sheet of paper between each transparency. The paper sleeves protect the phonograph records from dust build-up during storage, as does the sheet of paper between each transparency. Further, rolls for printing processes or rolls which are used to manufacture other items such as nonwoven materials, are generally shipped with a wrapping of a fairly heavy weight paper to protect the surface of the rolls.

Other methods of protecting an article with a sensitive surface include encasing the article in plastic films, such as polyvinylchloride films, polyethylene films or polypropylene films. In addition, sleeves or pockets prepared by laminating three sides of the two films together have also been used to protect compact disc and other articles with sensitive surfaces. Woven fabrics and nonwoven fabrics have also been used to protect items with sensitive surfaces.

In recent years, protective sleeves for compact disc have been prepared by laminating a nonwoven fabric with a film material. Typically, the film material is a polyvinylchloride film or a polypropylene film. In the earlier nonwoven fabric containing compact disc protective sleeves, the nonwoven fabric was usually laminated to another material such as a film, to provide strength to the nonwoven material and the overall structure of the sleeves.

U.S. Pat. No. 5,556,683 to Ranalli describes a protective sleeve containing a laminate of a fuzzy nonwoven polypropylene fabric thermally bonded to a polypropylene film. The '683 patent suggests to improve the stability and durability of the nonwoven sheet by laminating the nonwoven fabric to a backing layer of polypropylene film, using a polypropylene adhesive to adhere the nonwoven fabric to the polypropylene backing layer.

U.S. Pat. No. 5,462,160 to Youngs describes a storage container for compact disc having a nonwoven fabric laminated to a backing material to form a laminate. The preferred nonwoven fabric is produced from a polyester fiber and is not thermally bonded. This laminate was then joined to a flexible sheet, which is preferably transparent and has a cut to form a flap for inserting the compact disc.

Japanese Patent Publication 08-026367A describes using a nonwoven fabric as a separating layer between two flexible synthetic resin sheets to store compact disc. In this Japanese Publication, the nonwoven fabric is not laminated to a support layer. A compact disc can be stored on either side of the nonwoven fabric and multiple discs can be stored on each storage sleeve. The particular type of nonwoven fabric or the method in which the nonwoven fabric is made is not disclosed in this patent publication.

U.S. Pat. No. 6,186,320 to Drew discloses a double-sided sleeve containing a single sheet of a nonwoven material for holding compact discs. The nonwoven material is sandwiched between two flexible films and at least three edges of each film and the nonwoven material is interconnected to form pockets on both sides of the nonwoven material. The flexible films are a plastic material such as polyvinylchloride or polypropylene. As is disclosed in this patent, the nonwoven fabric is a unique polypropylene spunbond that is manufactured in a special process in which the spinnerets move back and forth over the moving forming belt to orient the fibers diagonally to the direction of the belt, creating biaxially oriented sheets. As is stated in this patent, a nonwoven fabric prepared using a conventional spunbond method does not have sufficient strength in both directions, hence the conventionally prepared spunbond will have a tendency to tear in one direction.

U.S. Pat. No. 5,692,607 to Brosmith et al, describes a protective sleeve comprising two outer flexible sheets typically, prepared from a polypropylene film. An inner wall is described as having protuberances to reduce the surface area of the sensitive surface having direct contact with the protective sleeve. Although this patent does not describe using a nonwoven fabric having protuberances, it is believed by the inventors of present invention that a product was commercially sold, by the assignee of the '607 patent, wherein an intermediate layer was placed between the flexible sheets and the intermediate layer was a polypropylene spunbond nonwoven fabric bonded with a pattern having continuous bonded areas defining a plurality of discrete unbonded areas However, this nonwoven fabric does not have the bulk density and stiffness of the present invention and the nonwoven web was produced from monoconstituent fibers. The point unbonded bond pattern is describe in detail in U.S. Pat. No. 5,858,515 to Stokes et al., and assigned to the Assignee of the present invention.

The prior art materials for protecting sensitive surfaces have not been effective to the desired degree in protecting sensitive surfaces from damage cause by particles such as dirt, dust and/or other particulate contaminants. It is believed that the current materials and methods have not been as effective in protecting sensitive surfaces for one or more of the following reasons: 1) the materials do not entrap particles such as dust, dirt or other particulate contaminants (in the case of paper or films); 2) the materials capture particles but do not effectively prevent redepositing of the captured particles on the sensitive surface or 3) the materials have a limited ability to entrap particles such as dust, dirt or other particluate contaminants.

There is a need in the art to provide a protective material for sensitive surfaces that will entrap and capture particles which may cause damage to the sensitive surface, such as dirt, dust and other particulate contaminants, and will protect and minimize damage to sensitive surfaces.

### SUMMARY OF THE INVENTION

The primary objective of the present invention is to provide a material which will protect sensitive surfaces of articles having at least one sensitive surface by minimizing damage to the sensitive surface caused by particles, such as dust, dirt and other particulate contaminants.

It is another object of the present invention to provide a material that will entrap particles, such as dirt, dust and other particulate contaminants, present on a sensitive surface which may come into contact with the material and will not redeposit the particles on the sensitive surface after the particles are entrapped by the material.

Another object of the present invention is to provide a storage sleeve which removes and entraps particles, such as dust, dirt and other particulate contaminants, from a sensitive surface of an article as the article is inserted into the sleeve and removed from the sleeve. It has been discovered that the storage sleeve article of the present invention entraps dirt, dust and other particulate contaminants, which will in turn lessen the severity of any scratches caused to the sensitive surface as the article is inserted and removed from the storage sleeve.

It has been discovered, as a result of the present invention, that a nonwoven web having a bulk density in the range of about 0.075 g/cc to about 0.130 g/cc, a Gurley stiffness greater than about 80 mg and voids capable of entrapping particles is effective in removing particles, such as dirt, dust and other particulate contaminants, from a sensitive surface and entrapping the particles within the nonwoven web. It has further been discovered that the nonwoven web of the present invention is very effective in preventing the majority of the removed particles from being redeposited onto the surface in which they were removed.

It has further been discovered that a nonwoven web having a bulk density in the range of about 0.075 g/cc to about 0.130 g/cc, a Gurley stiffness greater than about 80 mg and voids capable of entrapping particles where the nonwoven web is produced from multicomponent fibers is effective in removing particles, such as dirt, dust and other particulate contaminants, especially if the nonwoven web is through-air bonded or has a point unbonded bond pattern.

The present invention also relates to protective sleeve capable of protecting an article with a sensitive surface wherein the sleeve is made from a nonwoven web having a bulk density in the range of about 0.075 g/cc to about 0.130 g/cc, a Gurley stiffness greater than about 80 mg and voids capable of entrapping particles within the nonwoven web structure.

A further aspect of the present invention relates to a storage sleeve for holding an article having a sensitive surface wherein the sleeve has a first web having a top edge, a bottom edge and two side edges and a second web comprising a nonwoven web having a bulk density in the range of about 0.075 g/cc to about 0.130 g/cc and a Gurley stiffness greater than about 80 mg and having a top edge, a bottom edge and two side edges. The first web is interconnected with the second web at or near the bottom edge and at or near the two side edges of the first web to form a pocket to capable of holding the article having a sensitive surface. In addition, a third web can be optionally interconnected with the first and second web, such that the second web is sandwiched between the first and third webs.

The present invention also relates to a method of protecting sensitive surfaces from damage caused by particles such as, dirt, dust and other particulate contaminants by placing a nonwoven web having a bulk density in the range of about 0.075 g/cc to about 0.130 g/cc, a Gurley stiffness greater than about 80 mg and voids capable of entrapping particles with the nonwoven web structure in contact with the sensitive surface.

### BRIEF DESCRIPTIONS OF THE DRAWINGS

FIG. 1 is a schematic drawing of a process line for making a nonwoven web used in this invention using a through air bonded process.

FIG. 2. is a schematic drawing of a process line for making a nonwoven web used in this invention using bonding rolls to impart a bond pattern on the nonwoven web.

FIG. 3 shows a perspective view and cross-section of an article of the present invention.

FIG. 4 shows a perspective view and cross-section of a storage sleeve of the present invention.

FIG. 5 shows a perspective view and cross-section of a storage sleeve having multiple pockets of the present invention.

### DEFINITIONS

As used herein, the term “sensitive surface” is intended to cover all surfaces which can be damaged by particles such as dirt, dust, or other particulate contaminants. Examples of items having sensitive surfaces include, but are not limited to, compact discs, photograph records, paintings, transparencies, lithographic plates, flexographic plates, photocopier rolls, polished steel surfaces, precision parts, painted surfaces, collectible coins, mirrors, glass surfaces, and surfaces of glass substitutes, such as polycarbonate and polymethacrylates.

As used herein, the term “compact disc” includes, compact digital audio disc, digitable video disc (also known as DVD), computer CD-ROMS, computer CD-R disc, computer CD-RW disc and other similar information storage discs.

As used herein, the term “fiber” includes both staple fibers, fibers which have a defined length between about 2 and about 20 mm, fibers longer than staple fiber but are not continuous, and continuous fibers, which are sometimes called “continuous filaments”. The method in which the fiber is prepared will determine if the if the fiber is a staple fiber or a continuous filament.

As used herein, the term “nonwoven web” means a web having a structure of individual fibers or threads which are interlaid, but not in an identifiable manner as in a knitted web. Nonwoven webs have been formed from many processes, such as, for example, meltblowing processes, spunbonding processes, and bonded carded web processes. The basis weight of nonwoven webs is usually expressed in ounces of material per square yard (osy) or grams per square meter (gsm) and the fiber diameters useful are usually expressed in microns, or in the case of staple fibers, denier. It is noted that to convert from osy to gsm, multiply osy by 33.91.

The term “denier” is defined as grams per 9000 meters of a fiber. For a fiber having circular cross-section, denier may be calculated as fiber diameter in microns squared, multiplied by the density in grams/cc, multiplied by 0.00707. A lower denier indicates a finer fiber and a higher denier indicates a thicker or heavier fiber. Outside the United States the unit of measurement is more commonly the “tex,” which is defined as the grams per kilometer of fiber. Tex may be calculated as denier/9. The “mean fiber denier” is the sum of the deniers for each fiber, divided by the number of fibers.

As used herein, the term “bulk density” refers the weight of a material per unit of volume and is generally expressed in units of mass per unit bulk volume (e.g., grams per cubic centimeter).

As used herein, the term “spunbonded fibers” refers to fibers which are formed by extruding molten thermoplastic material as filaments from a plurality of fine, usually circular capillaries of a spinneret with the diameter of the extruded filaments then being rapidly reduced as by, for example, U.S. Pat. Nos. 4,340,563 to Appel et al., and 3,692,618 to Dorschner et al., 3,802,817 to Matsuki et al., 3,338,992 and 3,341,394 to Kinney, 3,502,763 to Hartman; 3,542,615 to Dobo et al.; and 5,382,400 to Pike et al.; the entire content of each is incorporated herein by reference. Spunbond fibers are generally not tacky when they are deposited onto a collecting surface. Spunbond fibers are generally continuous and have average diameters (from a sample of at least 10) larger than 7 microns to about 50 or 60 microns, more particularly, between about 10 and 20 microns.

As used herein, the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241. Meltblown fibers are microfibers which may be continuous or discontinuous, are generally smaller than 10 microns in average diameter, and are generally tacky when deposited onto a collecting surface.

As used herein, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “machine direction” or “MD” means the length of a web in the direction in which it is produced. The term “cross machine direction” or “CD” means the width of web, i.e. a direction generally perpendicular to the MD.

As used herein, the term “conjugate fibers” refers to fibers or filaments which have been formed from at least two polymers extruded from separate extruders but spun together to form one fiber. Conjugate fibers are also sometimes referred to as “multicomponent” or “bicomponent” fibers or filaments. The polymers are usually different from each other though conjugate fibers may be monocomponent fibers. The polymers are arranged in substantially constantly positioned distinct zones across the cross-section of the conjugate fibers or filaments and extend continuously along the length of the conjugate fibers or filaments. The configuration of such a conjugate fiber may be, for example, a sheath/core arrangement, wherein one polymer is surrounded by another, a side-by-side arrangement, a pie arrangement or an “islands-in-the-sea” arrangement. Conjugate fibers are taught in U.S. Pat. No. 5,108,820 to Kaneko et al., U.S. Pat. No. 5,336,552 to Strack et al., and U.S. Pat. No. 5,382,400 to Pike et al., the entire content of each is incorporated herein by reference. For two component fibers or filaments, the polymers may be present in ratios of 75/25, 50/50, 25/75 or any other desired ratios.

As used herein, the term “multiconstituent fibers” refers to fibers which have been formed from at least two polymers extruded from the same extruder as a blend or mixture. Multiconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random.

As used herein, the term “hot air knife” or HAK means a process of pre- or primarily bonding a just produced microfiber web, particularly spunbond, in order to give it sufficient integrity, i.e. increase the stiffness of the web, for further processing, but does not mean the relatively strong bonding of secondary bonding processes like through-air bonding, thermal bonding and ultrasonic bonding. A hot air knife is a device which focuses a stream of heated air at a very high flow rate, generally from about 1000 to about 10,000 feet per minute (fpm) (305 to 3050 meters per minute), or more particularly from about 3000 to 6000 feet per minute (915 to 1830 meters per minute) directed at the nonwoven web immediately after the nonwoven web formation. The air temperature is usually in the range of the melting point of at least one of the polymers used in the web, generally between about 200° and 550° F. (93° and 290° C.) for the thermoplastic polymers commonly used in spunbonding. However, the temperature of the air must be adjusted accordingly for the particular polymers used to prepare the nonwoven web. The control of air temperature, velocity, pressure, volume and other factors helps avoid damage to the web while increasing its integrity. The HAK's focused stream of air is arranged and directed by at least one slot of about ⅛ to 1 inches (3 to 25 mm) in width, particularly about ⅜ inch (9.4 mm), serving as the exit for the heated air towards the web, with the slot running in a substantially cross-machine direction over substantially the entire width of the web. In other embodiments, there may be a plurality of slots arranged next to each other or separated by a slight gap. The at least one slot is usually, though not essentially, continuous, and may be comprised of, for example, closely spaced holes. The HAK has a plenum to distribute and contain the heated air prior to its exiting the slot. The plenum pressure of the HAK is usually between about 1.0 and 12.0 inches of water (2 to 22 mmHg), and the HAK is positioned between about 0.25 and 10 inches and more preferably 0.75 to 3.0 inches (19 to 76 mm) above the forming wire. In a particular embodiment the HAK plenum's cross sectional area for cross-directional flow (i.e. the plenum cross sectional area in the machine direction) is at least twice the total slot exit area. Since the forming wire onto which spunbond polymer is formed generally moves at a high rate of speed, the time of exposure of any particular part of the web to the air discharged from the hot air knife is less a tenth of a second and generally about a hundredth of a second in contrast with the through-air bonding process which has a much larger dwell time. The HAK process has a great range of variability and controllability of many factors such as air temperature, velocity, pressure, volume, slot or hole arrangement and size, and the distance from the HAK plenum to the web. The HAK is further described in U.S. Pat. No. 5,707,468 to Arnold et al., the entire contents of which is incorporated by reference.

As used herein, through-air bonding or “TAB” means a process of bonding a nonwoven fiber web in which air, which is sufficiently hot to melt one of the polymers of which the fibers of the web are made, is forced through the web. The air velocity is between 100 and 500 feet per minute and the dwell time may be as long as 10 seconds. The melting and resolidification of the polymer provides the bonding. Through-air bonding has relatively restricted variability and since through-air bonding requires the melting of at least one component to accomplish bonding, it is generally restricted to webs with two components like conjugate fibers or those which include an adhesive. In the through-air bonder, air having a temperature above the melting temperature of one component and below the melting temperature of another component is directed from a surrounding hood, through the web, and into a perforated roller supporting the web. Alternatively, the through-air bonder may be a flat arrangement wherein the air is directed vertically downward onto the web. The operating conditions of the two configurations are similar, the primary difference being the geometry of the web during bonding. The hot air melts the lower melting polymer component and thereby forms bonds between the filaments to integrate the web.

As used herein “pattern unbonded” or interchangeably “point unbonded” or “PUB”, means a fabric pattern having continuous bonded areas defining a plurality of discrete unbonded areas. The fibers or filaments within the discrete unbonded areas are dimensionally stabilized by the continuous bonded areas that encircle or surround each unbonded area, such that no support or backing layer of film or adhesive is required. The unbonded areas are specifically designed to afford spaces between fibers or filaments within the unbonded areas. A suitable process for forming the pattern-unbonded nonwoven material of this invention includes providing a nonwoven fabric or web, providing opposedly positioned first and second calender rolls and defining a nip there between, with at least one of said rolls being heated and having a bonding pattern on its outermost surface comprising a continuous pattern of land areas defining a plurality of discrete openings, apertures or holes, and passing the nonwoven fabric or web within the nip formed by said rolls. Each of the openings in said roll or rolls defined by the continuous land areas forms a discrete unbonded area in at least one surface of the nonwoven fabric or web in which the fibers or filaments of the web are substantially or completely unbonded. Stated alternatively, the continuous pattern of land areas in said roll or rolls forms a continuous pattern of bonded areas that define a plurality of discrete unbonded areas on at least one surface of said nonwoven fabric or web. The PUB pattern is further described in U.S. Pat. No. 5,858,515 to Stokes et al, the entire contents of which are hereby incorporated by reference.

### Test Procedure

Gurley Stiffness: The Gurley Stiffness test measures the bending resistance of a material. It is carried out according to TAPPI Method T 543 om-94 and is measured in milligrams and reported as an average of 5 sample readings. The sample size used for the testing herein was 1.5 inch (3.8 cm) in the MD by 1 inch (2.54 cm) in the CD.

### DETAILED DESCRIPTION

The sensitive surface protective material of the present invention comprises a nonwoven web. Any known method for preparing nonwoven webs may be used to prepare the nonwoven web sensitive surface protective material of the present invention. For example, the nonwoven web can be prepared using a spunbond process, a meltblown process or other known nonwoven web forming processes. It is important, however, that the nonwoven web have a nonwoven web having a bulk density less than about 0.130 g/cc but greater than about 0.075 g/cc, a Gurley stiffness greater than about 80 mg and voids which are capable of entrapping particles within the nonwoven structure.

The bulk density of the nonwoven web gives an indication of the density of the fibers in the nonwoven fabric. A high bulk density is an indication that the fibers are fairly dense within the nonwoven material, meaning that the voids between the individual fibers are small. In contrast, if the bulk density is relatively small, the voids between the individual fibers are large. If the nonwoven web has a bulk density greater than about 0.130 g/cc, the nonwoven web will not have sufficient voids or void size between the fibers to effectively remove, capture and hold contaminants, such as dust and dirt, from a sensitive surface. If the bulk density of the nonwoven web is below about 0.075 g/cc, the nonwoven web will have voids that are too large to effectively hold the particles and/or will not have enough integrity. It has been discovered if the bulk density of the nonwoven fabric is between about 0.075 g/cc and about 0.130 g/cc, the resulting voids present in the nonwoven web will be capable of removing particles from the sensitive surface and entrapping the particle within the nonwoven web structure, thereby preventing redepositing of the particles onto the sensitive surface. Preferably, the bulk density of the nonwoven fabric is between about 0.08 g/cc and about 0.125 g/cc, and most preferably, between about 0.09 g/cc and about 0.120 g/cc.

The Gurley Stiffness of the nonwoven web of the present invention should be at least about 80 mg. If the stiffness is below about 80 mg, the nonwoven will tend to be too flexible. As a result of the flexibility, any particles of dust, dirt or other contaminants entrapped by the nonwoven fabric will tend to be released by the nonwoven fabric. The inventors theorize, although the inventors do not wish to be bound by this theory, that when the nonwoven is too flexible, the fibers of the nonwoven web tend to move in relationship to one another, especially when the nonwoven web is flexed. This movement of fibers in relationship to one another causes any particles entrapped to be released from the fibers, thereby causing any entrapped dust, dirt or other contaminants to be released by the nonwoven material, and subsequently redeposited onto the sensitive surface. It is noted that the upper limit of Gurley Stiffness is not critical to the present invention. However, the final utility of the nonwoven web will set an upper limit, and that upper limit will be readily apparent to those skilled in the art. For example, in the case when the nonwoven fabric is to be used as a conforming wrap, the Gurley Stiffness should be such that the wrap will be able to conform to the surface of the article to be wrapped. Preferably, the Gurley Stiffness should be at least 100 mg.

The nonwoven webs of the present invention may have basis weights ranging from about 0.25 osy (8.5 gsm) to about 50 osy (1700 gsm). The actual basis weight of the nonwoven material is dependent of the final use of the nonwoven. For example, if the nonwoven material is used in sleeve used for a compact disc, it is desirable that the basis weight be in the range from about 0.5 osy (17 gsm) to about 10 osy (340 gsm), and preferably about 1.5 osy (51 gsm) to about 2.5 osy (85 gsm). If the nonwoven material is used the protect larger or bulkier objects, such as lithographic rolls, which may need more cushioning, higher basis weights are preferred.

In order to improve the ability of the nonwoven web to draw dust, dirt and other such particulate contaminants from the sensitive surface into the nonwoven web, the nonwoven web may be surface treated. An example of such a surface treatment is an electret treatment of the nonwoven web.

Electret treatment can be carried out by a number of different techniques. One technique is described in U.S. Pat. No. 5,401,446 to Tsai et al. assigned to the University of Tennessee Research Corporation and incorporated herein by reference in its entirety. Tsai describes a process whereby a web or film is sequentially subjected to a series of electric fields such that adjacent electric fields have substantially opposite polarities with respect to each other. Thus, one side of the web or film is initially subjected to a positive charge while the other side of the web or film is initially subjected to a negative charge. Then, the first side of the web or film is subjected to a negative charge and the other side of the web or film is subjected to a positive charge. Such webs are produced with a relatively high charge density without an attendant surface static electrical charge. The process may be carried out by passing the web through a plurality of dispersed non-arcing electric fields which may be varied over a range depending on the charge desired in the web. The web may be charged at a range of about 1 kVDC/cm to about 12 kVDC/cm or more particularly about 4 kVDC/cm to about 10 kVDC/cm and still more particularly about 7 kVDC/cm to about 8 kVDC/cm.

Other methods of electret treatment are known in the art such as that described in U.S. Pat. Nos. 4,215,682 to Kubik et al, U.S. Pat. No. 4,375,718 to Wadsworth, U.S. Pat. No. 4,592,815 to Nakao and U.S. Pat. No. 4,874,659 to Ando, each hereby incorporated in its entirety by reference.

Preferably, the sensitive surface protective material of the present invention comprises a nonwoven web made by a spunbond process. The spunbond process generally uses a hopper which supplies polymer to a heated extruder. The extruder supplies melted polymer to a spinneret where the polymer is fiberized as it passes through fine openings arranged in one or more rows in the spinneret, forming a curtain of filaments. The filaments are usually quenched with air at a low pressure, drawn, usually pneumatically and deposited on a moving foraminous mat, belt or “forming wire” to form the nonwoven web. Polymers useful in the spunbond process generally have a process melt temperature of between about 400° F. to about 610° F. (200° C. to 320° C.).

The filaments produced in the spunbond process are usually in the range of from about 7 to about 50 microns in average diameter, depending on process conditions and the desired end use for the webs to be produced from such fibers. For example, increasing the polymer molecular weight or decreasing the processing temperature results in larger diameter fibers. Changes in the quench fluid temperature and pneumatic draw pressure can also affect fiber diameter. The fibers used in the practice of this invention usually have average diameters in the range of from about 7 to about 35 microns, more particularly from about 15 to about 25 microns. Further, when referring to “average” diameters, it is meant that it is an average of at least 10 samples.

The fibers used to produce the nonwoven web of the present invention are preferably multiconsituent fibers or conjugate fibers, especially if the nonwoven web is through-air bonded.

The polymers used to produce the fibers of the nonwoven web may be any thermoplastic polymer, including, but not limited to polymers such as polyolefins, polyamides (nylons), polyesters and copolymers and blends thereof. The preferred thermoplastic polymers are polyolefins, from the standpoint of cost and the properties provided. Specific examples of polyolefins include polyethylene and polypropylene.

Many polyolefins are available for fiber production, for example polyethylenes such as Dow Chemical's ASPUN 6811A linear low-density polyethylene, 2553 LLDPE and 25355 and 12350 high density polyethylene are such suitable polymers. The polyethylenes have melt flow rates in g/10 min. at 190° F. and a load of 2.16 kg, of about 26, 40, 25 and 12, respectively. Fiber forming polypropylenes include Exxon Chemical Company's ESCORENE PD3445 polypropylene. Many other polyolefins are commercially available and generally can be used in the present invention. The particularly preferred polyolefins are polypropylene and polyethylene.

As stated above, preferably, the fibers used in the preferred nonwoven web are conjugate fibers. As these conjugate fibers are produced and cooled, the differing coefficients of expansion of the polymers may cause these fibers to bend and ultimately to crimp, somewhat akin to the action of the bimetallic strip in a conventional room thermostat. Generally, as the crimp of the fiber increases, the bulk density of the web decreases and the web stiffness decreases. Fibers varying in crimp from highly crimped to essentially free of crimp may be used in the practice of this invention depending on the stiffness requirements of the user. When the nonwoven web of the present invention is through-air bonded, it is preferred that the fibers are free of any crimp or are essentially free of crimp. In contrast, when the nonwoven web is bonded in a PUB bond pattern, it is preferred that the fibers are at least somewhat crimped. The preferred conjugate fibers are sheath/core or side-by-side (S/S) fibers. It is also preferred, but not required, that one component of the conjugate fibers contains polyethylene and the second component contains polypropylene. If the conjugate fibers are in a sheath/core configuration, it is preferred, but not required, that the sheath contains polyethylene and the core contains polypropylene, as polymeric components.

After the fibers are formed and deposited on the forming wire and create the web of this invention, the web may be passed through a hot air knife or HAK to very slightly consolidate the web and provide the web with enough integrity for further processing. After deposition but before HAK treatment, the fiber web has low stiffness which makes its difficult, if not impossible, to successfully convert on commercially available converting equipment commonly used to the final use. The application of the HAK allows forming a web of fibers to deliver high stiffness by melting only a portion of the lower melting component in the web, preferably only that lower melting component on the side facing the HAK air, in a pre- or primary bonding step. This HAK step creates a zone of pre-bonded fibers located on one side of the web which then undergo a second melting when exposed to through-air bonding or bonding with a heated bonding roll, such as a roll which will impart a PUB pattern to the nonwoven web. The exposure of this zone to at least two heating and melting cycles is believed to create a zone of high stiffness in the web from the crystallization of the polymer, however, since the zone is comprised of a small percentage of the total web, the effect on bulk density of the web is minimized. This differs from the commonly used method of increasing the integrity of a web known as compaction rolls since while compaction rolls increase the stiffness of a web, the compaction rolls also increase the bulk density of the web. It is noted, however, that while compaction rolls may be used in the practice of this invention, the HAK is substantially preferred. After treatment with the HAK, the web is sufficiently cohesive to move it to the next step of production; the secondary bonding step. Any secondary bonding known to those skilled in the art can be used so long as the resulting nonwoven web has the desired claimed stiffness, bulk density and ability to entrap particles.

The secondary bonding procedure which may be used in the practice of this invention is preferably through-air bonding because it does not appreciably reduce web void (pore) size. When used with HAK pre-bonding, through-air bonding very effectively produces high stiffness in the web since it provides a second heating of the polymer previously heated by the HAK and provides sufficient heat to bond fibers not bonded by the HAK. This creates bonds at almost every fiber crossover point, thereby restricting movement of the majority of the fibers of the web.

In a second preferred secondary bonding method, a point unbonded (PUB) bond pattern can be used. In the PUB pattern, a continuous bond area is formed with a plurality of discrete unbonded areas. The continuous bond area provides sufficient stiffness to the nonwoven web and the unbonded areas provide sufficient bulk density and void to effectively hold the particles within the web structure. Thermal point bonding by contrast results in bonds at discrete points, thereby allowing the fibers between the bond points the freedom to bend and rotate individually and so producing a much smaller increase in stiffness.

Another method of increasing web stiffness is by simply increasing the basis weight of the web. This technique, however, is undesirable since it also increases the cost of the nonwoven web. The HAK in conjunction with through-air bonding or PUB bonding allows for increasing the stiffness of a web without the cost penalty associated with increasing the basis weight of the web.

After through-air bonding or PUB bonding, the web may be optionally surface treated to adjust the surface properties. Examples of the surface treatment includes electret treatment. Electret treatment, which is described above, further increases the ability of the nonwoven web to protect sensitive surfaces by drawing particles, such as dust and dirt, into the nonwoven web by virtue of their electrical charge. Other surface treatments can be used, such as, placing a surfactant onto the surface of the formed nonwoven web.

Alternatively, the polymers used to make the nonwoven web may contain additives, such as surfactants or slip agents, to aid in the sliding of the sensitive surface against the nonwoven material. Other additives, such as pigments, dyes, processing aids and the like can be added to the polymer prior to fiber formation, provided that the additives do not adversely affect the ability of the nonwoven web to remove particles from a sensitive surface and entrap the removed particles.

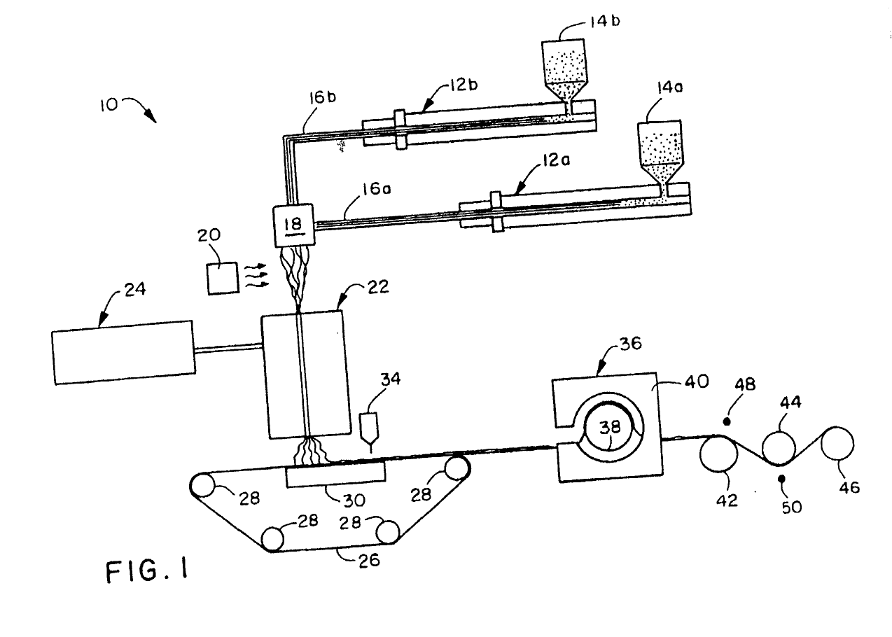

Turning to the FIG. 1, a process line 10 for preparing a preferred nonwoven web used in the present invention is disclosed. The process line 10 is arranged to produce conjugate continuous filaments, but it should be understood that the present invention comprehends nonwoven webs made with multicomponent filaments having more than two components. For example, the web of the present invention can be made with filaments having three, four or more components. The process line 10 includes a pair of extruders 12a and 12b for separately extruding a polymer component A and a polymer component B. Polymer component A is fed into the respective extruder 12a from a first hopper 14a and polymer component B is fed into the respective extruder 12b from a second hopper 14b. Polymer components A and B are fed from the extruders 12a and 12b through respective polymer conduits 16a and 16b to a spinneret 18. Spinnerets for extruding conjugate filaments are well-known to those of ordinary skill in the art and thus are not described herein detail. Generally described, the spinneret 18 includes a housing containing a spin pack which includes a plurality of plates stacked one on top of the other with a pattern of openings arranged to create flow paths for directing polymer components A and B separately through the spinneret. The spinneret 18 has openings arranged in one or more rows. The spinneret openings form a downwardly extending curtain of filaments when the polymers are extruded through the spinneret. For the purposes of the present invention, spinneret 18 may be arranged to form side-by-side or eccentric sheath/core conjugate filaments, for example.

The process line 10 also includes a quench blower 20 positioned adjacent the curtain of filaments extending from the spinneret 18. Air from the quench air blower 20 quenches the filaments extending from the spinneret 18. The quench air can be directed from one side of the filament curtain as shown in FIG. 1, or both sides of the filament curtain.

A fiber draw unit or aspirator 22 is positioned below the spinneret 18 and receives the quenched filaments. Fiber draw units or aspirators for use in melt spinning polymers are well-known as discussed above. Suitable fiber draw units for use in the process of the present invention include a linear, fiber aspirator of the type shown in U.S. Pat. No. 3,802,817 or U.S. Pat. No. 4,340,563 and eductive guns of the type shown in U.S. Pat. Nos. 3,692,618 and 3,423,266, each hereby incorporated by reference in its entirety. Generally described, the fiber draw unit 22 includes an elongate vertical passage through which the filaments are drawn by aspirating air entering from the sides of the passage and flowing downwardly through the passage. A blower 24 supplies hot aspirating air to the fiber draw unit 22. The hot aspirating air draws the filaments and ambient air through the fiber draw unit.

An endless forming surface 26 is positioned below the fiber draw unit 22 and receives the continuous filaments from the outlet opening of the fiber draw unit. The forming surface 26 travels around guide rollers 28. A vacuum 30 positioned below the forming surface 26 where the filaments are deposited draws the filaments against the forming surface.

The process line 10 as shown also includes a hot-air knife 34 which provides a degree of integrity to the web. In addition, the process line includes a bonding apparatus which is a through-air bonder 36. After passing through the through-air bonder, the web is passed between a charging wire or bar 48 and a charged roller 42 and then between a second charging wire or bar 50 and roller 44. As is stated above, the electret treatment is an optional process step and is not required.

Lastly, the process line 10 includes a winding roll 42 for taking up the finished web. To operate the process line 10, the hoppers 14a and 14b are filled with the respective polymer components A and B. Polymer components A and B are melted and extruded by the respective extruders 12a and 12b through polymer conduits 16a and 16b and the spinneret 18. Although the temperatures of the molten polymers vary depending on the polymers used, when polypropylene and polyethylene are used as components A and B respectively, the preferred temperatures of the polymers range from about 370° to about 530° F. and preferably range from about 400° to about 450° F.

As the extruded filaments extend below the spinneret 18, a stream of air at a temperature of about 70° to about 90° F. from the quench blower 20 at least partially quenches the filaments to develop a latent helical crimp in the filaments. and a velocity from about 100 to about 400 feet per minute. Alternatively, cooler air may be used to minimize crimp, if desired. Preferably, the cooler air is generally in the range of about 40° F. to about 70° F.

After quenching, the filaments are drawn into the vertical passage of the fiber draw unit 22 by a flow of air from the blower 24 through the fiber draw unit. The fiber draw unit is preferably positioned about 30 to about 60 inches below the bottom of the spinneret 18. The temperature of the air supplied from the blower 24 is sufficient that, after some cooling due to mixing with cooler ambient air aspirated with the filaments, the air heats the filaments to a temperature required to activate the latent crimp, if crimps are desired. The temperature required to activate any latent crimp of the filaments ranges from about 110° F. to a maximum temperature less that the melting point of the lower melting component which for through-air bonded materials is the second component B. The temperature of the air from the blower 24 and thus the temperature to which the filaments are heated can be varied to achieve different levels of crimp. Generally, a higher air temperature produces a higher number of crimps. The ability to control the degree of crimp of the filaments is a particularly advantageous feature of the present invention because it allows one to change the resulting bulk density, void size distribution and stiffness of the web by simply adjusting the temperature of the air in the fiber draw unit.

The filaments are deposited through the outlet opening of the fiber draw unit 22 onto the traveling forming surface 26. The vacuum 30 draws the filaments against the forming surface 26 to form an unbonded, nonwoven web of continuous filaments. The web is then given a degree of integrity by the hot-air knife 34 and through-air bonded in the through-air bonder 36.

In the through-air bonder 36, air having a temperature above the melting temperature of component B and below the melting temperature of component A is directed from the hood 40, through the web, and into the perforated roller 38. Alternatively, the through-air bonder may be a flat arrangement wherein the air is directed vertically downward onto the web. The operating conditions of the two configurations are similar, the primary difference being the geometry of the web during bonding. The hot air melts the lower melting polymer component B and thereby forms bonds between the conjugate filaments to integrate the web. When polypropylene and polyethylene are used as polymer components A and B respectively, the air flowing through the through-air bonder usually has a temperature ranging from about 230° F. to about 325° F. (110° C. to 162° C.) and a velocity from about 100 to about 500 feet per minute. It should be understood, however, that the parameters of the through-air bonder may be varied outside of the above parameters depending on factors such as the type of polymers used, thickness of the web, the length of the bonder and the line speed in which the nonwoven web is run through the bonder.

The nonwoven web is then optionally passed through the charged field between the charging bar or wire 48 and the charging drum or roller 42 and then through a second charged field of opposite polarity created between charging bar or wire 50 and charging drum or roller 44. The web may be charged at a range of about 1 kVDC/cm to about 12 kVDC/cm.

Lastly, the finished web is wound onto the winding roller 42 and is ready for further treatment or use. As an alternative to the winding roll 42, the nonwoven web could be further processed in-line to form a final product or to alter the physical characteristics of the product, such as width or length of the nonwoven web.

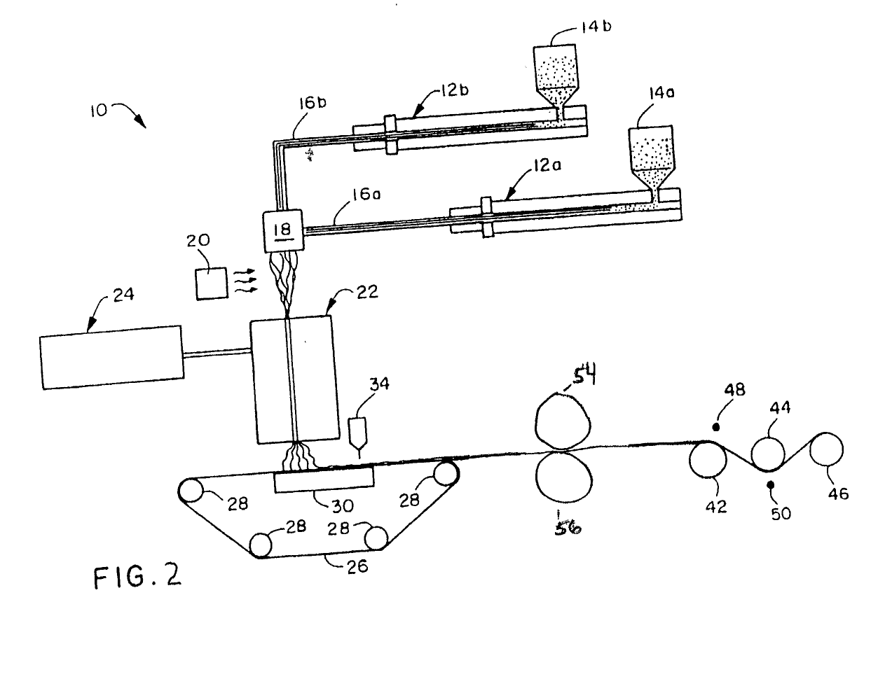

Referring to FIG. 2, the process is essentially identical to the process described above, except the through-air bonder is replaced with bonding rolls. The detailed description of FIG. 2, will therefore focus on the process after the hot air knife (“HAK”) and reference is made to the description of FIG. 1 above. FIG. 2 illustrates an exemplary bonding pattern bonding process. The pattern bonding process employs pattern bonding roll pairs 54 and 56 for effecting bond points at limited areas of the web by passing the web through the nip formed by the bonding rolls 54 and 56. One or both of the roll pair have a pattern of land areas and depressions on the surface, which effects the bond points, and are heated to an appropriate temperature. The temperature of the bonding rolls and the nip pressure are selected so as to effect bonded regions without having undesirable accompanying side effects such as excessive shrinkage and web degradation. Although appropriate roll temperatures and nip pressures are generally influenced by parameters such as web speed, web basis weight, fiber characteristics, component polymers and the like, the roll temperature desirably is in the range between the softening point and the crystalline melting point of the lowest melting component polymer.

Any bond pattern known to those skilled in the art can be used in the present invention, so long as the resulting nonwoven web has a bulk density in the range of about 0.075 g/cc to about 0.130 g/cc, a Gurley stiffness greater than about 80 mg and voids within the nonwoven web structure capable of entrapping particles. Preferably, the bond pattern of the rolls will impart a point unbonded pattern, which is described above.

As is FIG. 1, the nonwoven web is then optionally passed through the charged field between the charging bar or wire 48 and the charging drum or roller 42 and then through a second charged field of opposite polarity created between charging bar or wire 50 and charging drum or roller 44. The web may be charged at a range of about 1 kVDC/cm to about 12 kVDC/cm.

Lastly, the finished web is wound onto the winding roller 42 and is ready for further treatment or use. As in FIG. 1, the web may alternatively be further processed in-line instead of winding the material on to a winding roller.

In the practice of the present invention, if the PUB bond pattern is used as the secondary bonding, then it is preferred that the filaments have crimps. The degree of crimp is not critical to the present invention, provided that the stiffness and bulk density are within the ranges discussed above. The degree of crimp can be adjusted by adjusting the by those skilled in the art, by adjusting the temperature of the air from the quench blower, as described above. Further, it is noted that if the nonwoven web of the present invention is through-air bonded, then it is preferred, although not required, that the fibers have no crimps or a low degree of crimp as possible.

In the present invention, the sensitive surface protective material can be used in a variety of ways to protect an article having sensitive surfaces. Essentially, the sensitive surface protective material of the present invention can be used in any application where a protective layer has been previously used. In the simplest form, the sensitive surface protective material is placed into contact with the sensitive surface by, for example, laying the sensitive surface protective material on the sensitive surface or adhering the sensitive surface protective material to the sensitive surface by a means known to those skilled in the art. Stacks of articles with sensitive surfaces could be formed using the sensitive surface protective material of the present invention as a spacer protective layer placed between each article in the stack. Alternatively, the sensitive surface protective material can be used to wrap the article having sensitive surfaces. Examples of wraps include wraps which conform to the shape of the article having the sensitive surface.

In other aspects of the present invention, the sensitive surface protective material can be formed by further processing the nonwoven web to form an article, such as a sleeve having a desired shape. By the use of the phrase “desired shape”, it should be understood by those skilled in the art that the shape of the sleeve is such that the sleeve is capable of holding or storing the article having sensitive surfaces. For example, in the case of lithographic or similar rolls, the nonwoven web could be formed into a sleeve having a generally cylindrical shape. Likewise, if the article has a generally rectangular shape, the sleeve prepared from the nonwoven web could have a generally rectangular shape. As for article have a generally circular or triangular shape can also be protected and stored in sleeve having a rectangular or square shape or any other shape capable of holding the article.

Sleeves made from the nonwoven web of the present invention can be prepared in a variety of different ways. The sleeves are capable of holding articles having a sensitive surface and will protect the sensitive surface from damage during storage or shipping.

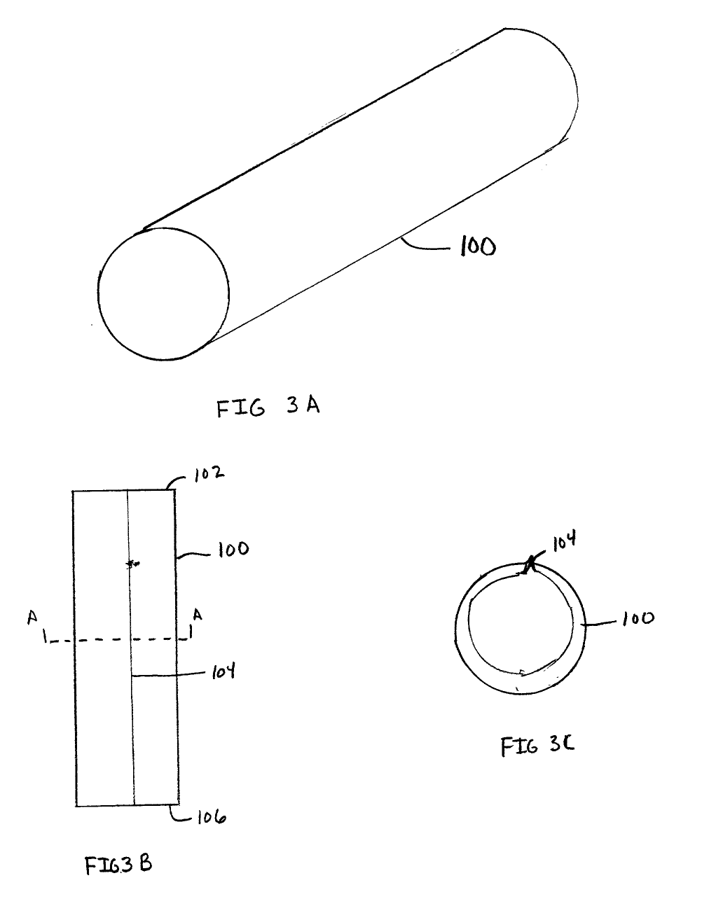

For example, a single piece of the nonwoven web having a top edge, a bottom edge and two side edges could be formed into a generally cylindrical article by rolling the web such that the two side edges come into contact with one another, forming a seam along the length of contact of the two edges by joining the two edges together, and enclosing the bottom edge by joining or sealing the material together. In this regard, attention is directed to FIG. 3A, which shows a perspective view of a cylindrical sleeve 100. FIG. 3B is a side view of the sleeve 100 and FIG. 3C is cross-section of the sleeve 100 along line A-A. The top end 102 is left open so that the cylindrical article having a sensitive surface can be easily inserted into the sleeve 100. The seam 104 along the length of the cylinder and the enclosing of the bottom 106 end can be accomplished by any suitable means known to those skilled in the art, including, but not limited to, adhesive bonding, thermal bonding (welding), or stitching.

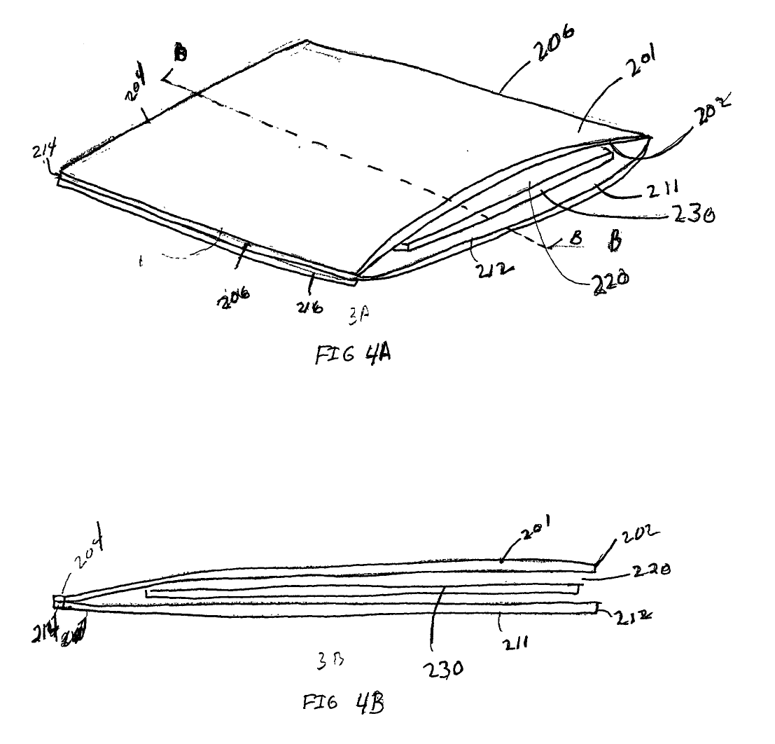

A storage sleeve for holding an article having at least one sensitive surface to protect the sensitive surface from damage can also be prepared from two or more webs. To illustrate an example of such a storage sleeve, attention is directed to FIG. 4. FIG. 4A is a perspective view of the storage sleeve 200 and FIG. 4B is a cross-section along line B-B. A first web 201 having a top edge 202, a bottom edge 204 and two side edges 206 and a second web 211 comprising a nonwoven web having a bulk density in the range of about 0.075 g/cc to about 0.130 g/cc and a Gurley stiffness greater than about 80 mg and having a top edge 212, a bottom edge 214 and two side edges 216. The first web is interconnected together on at least the bottom edge and the two side edges of the first web 201 to form a pocket having an opening 220 to hold the said article having a sensitive surface 230. It is noted, although not shown in the figures, that the second web may extend beyond the first web, such that the first web is not bonded to the edges of the second web. In a similar manner, the first web does not have to be bonded exactly at the bottom edge and two side edges, but can be bonded inward from the edge of the first web such that there is excess first web and/or second web beyond the bond seam, such as in an inner seem of a article of clothing. Preferably, however, the second web is interconnected to the first web along the two side edges 216 and the bottom edge 214. The first web 201 can be paper, a film, a woven web, or a nonwoven web. If the first web is a nonwoven web, it is preferred, although not required, that the first web is a nonwoven web having a bulk density in the range of about 0.075 g/cc to about 0.130 g/cc, a Gurley stiffness greater than about 80 mg and voids within the nonwoven web structure capable of entrapping particles. The interconnection of the first and second webs can be accomplished by any method known to those skilled in the art including, but not limited to, adhesive bonding, thermal bonding (welding) or stitching. Preferably, the first and second webs are interconnected via thermal bonding.

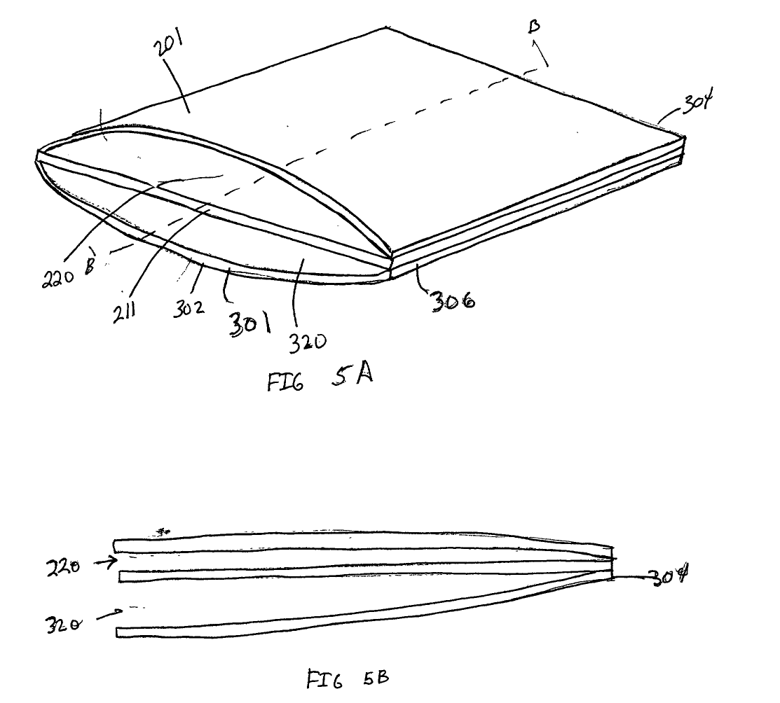

Additionally, a storage sleeve can be prepared having more than one storage compartment. FIG. 5A is a perspective view of the storage sleeve 300 and FIG. 5B is a cross-section along line B-B. It is noted that FIG. 5 is similar to FIG. 4 except FIG. 5 shows a storage sleeve with two pockets. As shown in FIG. 5A, a third web 301 having a top edge 302, a bottom edge 304 and two side edges 306 could be interconnected with first web 201 and the second web 211 such that the second nonwoven web 211 is positioned between the first web 201 and the third web 301, and the first web 201, and the third web 301 are interconnected together on at least the bottom edge and the two side edges with the second web 211 of each to form a two pocket having openings 320 and 220 to hold an article having a sensitive surface on each side of the nonwoven second web 211. Like the first web 201 and the third web 301 can be paper, a film, a woven material or a nonwoven material. Further, storage sleeves having additional pockets can be formed by adding additional webs in a similar fashion. The storage sleeves of the present invention can have as many storage compartments as desired. When the storage sleeve has more than two pockets, however, it is preferred that the inner webs, the webs without a surface of the web on the outside of the sleeve, are nonwoven webs having a bulk density in the range of about 0.075 g/cc to about 0.130 g/cc and a Gurley stiffness greater than about 80 mg.

If the first web 201 and/or the third web 301 is a nonwoven web, it is preferred that the webs is a nonwoven web having a bulk density in the range of about 0.075 g/cc to about 0.130 g/cc and a Gurley stiffness greater than about 80 mg. This will provide a storage sleeve that will have contaminant, such as dirt or dust, entrapping properties on all inner surfaces of the sleeve.

The first web and/or the third web described above can also be a film material. Examples of possible film materials include polyolefin film, polyvinylchloride films and the like. When a film is used, typically only one side of the article inserted into the sleeve will have a sensitive surface. If a film material is used as the first web and/or third web, the film is preferably transparent, however, the film is not required to be transparent. This will allow the user of the storage sleeve to see the item in the sleeve without removing the article from the sleeve. It is preferred, but not required, to use a transparent film when the item to be stored is, for example, a compact disc.

The polyolefins used as a film material of the present invention includes, but are not limited to, polypropylene and polyethylene films. Preferably, the film is a polyethylene film, since polypropylene films have a tendency to “cold crack” under various temperatures which the compact disc sleeves may be subjected to. However, in order to use a polyethylene film, the nonwoven web must be compatible with the polyethylene film. If the nonwoven material is not compatible with the polyethylene film, the polyethylene film and nonwoven material will have a tendency to delaminate.

Using the nonwoven web of the present invention comprising a multicomponent side-by-side fiber having at least one component comprising polyethylene, will be compatible with the polyethylene film. This provides a low cost alternative to the polypropylene films typically used in protective CD sleeves.

As an effect of the present invention, as an article with a sensitive surface is inserted and/or removed from the sleeve, the nonowoven web provides a squeegee effect, thereby removing the dirt, dust and other particulate contaminants from the sensitive surface. The low bulk density of the nonwoven web helps to remove dirt, dust and other particulate contaminants from the sensitive surface more effectively, which reduces the amount of dirt, dust and other particulate contaminants that would be available to be redeposited on the sensitive surface. Further, the nonwoven web continues to wipe or clean the surface of the sensitive surface upon multiple repetitions/passes.

It is pointed out that since the dirt, dust and other particulate contaminants is not redeposited on the sensitive surface, the above described nonwoven web reduces the quantity and/or severity of scratches which occur to the sensitive surface. It should be understood by those skilled in the art that the nonwoven web described above does not prevent all scratches or damage from dust, dirt or other particulate contaminants, but the severity and quantity of the scratches is reduced. Conventional nonwoven webs used to protect sensitive surfaces tend to redeposited dust, dirt or other particulate contaminants since the conventional nonwoven web does not effectively allow the dust and dirt to enter the nonwoven web matrix. The described nonwoven web effectively allows the dust, dirt or other particulate contaminants to move into the web matrix (structure) upon multiple passes/wipes which allows it to continue to clean the dirt, dust and other particulate contaminants efficiently from the sensitive surface.

It has also been discovered that the nonwoven web used in the present invention has a lower coefficient of friction compared to conventional sleeve fabric used to protect compact discs. This allows a compact disc to slide in and out of the sleeve with less effort (force). Further, the nonwoven web used in the present invention has a higher rigidity (stiffness) than conventional nonwoven webs used in compact disc sleeves, i.e., conventional spunbond, which makes the nonwoven web of the present invention more resistant to wrinkles, which in turn increases the longevity or “like new” appearance of the sleeve.

Many different configurations for sleeves for holding articles with sensitive surfaces have been proposed and are generally known to those skilled in the art. For example, FIGS. 1-12 of U.S. Pat. No. 6,186,320, shows different configurations for holding compact disc. This patent, including the particular embodiments of FIGS. 1-12, is hereby incorporated by reference in its entirety. The sensitive surface protective material of the present invention can be used, without limitation, in any of the configurations shown in this patent, by replacing the nonwoven material suggest by the patentee of the '320 patent with the nonwoven material of the present invention. In addition, the nonwoven material of the present invention can be used in any other configuration of compact disc sleeves, replacing the currently used nonwoven material, known to those skilled in the art.

As other alternatives, the sensitive surface protective material of the present invention can be used in conjunction with other known protection methods, such as, for example, bubble wrap, films, cellular materials such as styrofoam and the like. The protective material may optionally be laminated to one or more protection methods or used allow as a separate protective layer.

### EXAMPLE

The nonwoven web of this invention was produced containing side-by-side conjugate spunbond fibers made according to U.S. Pat. No. 5,382,400 to Pike et al. The polymers used were ESCORENE PD-3155 polypropylene, available from Exxon-Mobil of Houston, Tex., and ASPUN XUS 61800.41 polyethylene available from the Dow Chemical Company of Midland, Mich. In producing the fabrics, the HAK air flowrate was between about 5000 to 6000 fpm (1524-1830 m/min), the HAK temperature was 320° F. and the HAK height above the web was 1.25 inches (3.1 cm). The fibers were extruded through spinnerets having a diameter of 0.6 mm to produce fibers having diameters from 18-22 microns. The polypropylene and polyethylene polymers were processed at a melt temperature of about 480° F. (249° C.). The webs were processed through a through-air bonder at a temperature of between about 195° F. and 270° F. (91-132° C.) at an air rate of between 350 to 650 fpm (107-198 m/min) for a time period of about 3 to 5 seconds. One fabric was treated according to the method of U.S. Pat. No. 5,401,446 by passing the web between a conductive bar or wire and a curved conductive drum with a non-arcing electric field between the bar or wire and the drum of about 7 kVDC/cm of separation between the bar and drum and then passing the web through a second electric field generated by the same means and as the same strength as the first but with the field orientation being 180 degrees of the first relative to the web.

A comparative fabric was obtained from Case Logic product number CD 64. The comparative fabric is a thermally point bonded polypropylene spunbond material. It is unknown if this fabric has been treated.

After formation, the webs were tested for stiffness, dust removal, and resistance to severe scratches.

TABLE

| | | | | | | Bulk |
|---|---|---|---|---|---|---|
| | Stiffness | % Dust | % CD's Scratched | | | Density |
| Sample | mg | Removed | Music | Data | COF | g/cc |
| Untreated | 140 | 83 | 20 | 0 | 69 | 0.10 |
| Treated | 138 | 74 | — | — | — | 0.10 |
| Comp | 45 | 51 | 80 | 80 | 96 | 0.16 |
| Fabric | | | | | | |

The results show that the fabrics of this invention have improved cleaning efficiency for dust and dirt particles and result in less severe scratches in the presence of dust and dirt when compared to commercially available fabrics. Due to the low bulk density, the fabrics of this invention provide improved protection and cushioning for sensitive materials. In addition, it can be seen from the above table that the coefficient of friction of the fabric of the present invention is lower than the commercially available product, indicating that the article will slide in and out of a sleeve prepared from the nonwoven web of the present invention.

While the invention has been described in detail with respect to specific embodiments thereof, and particularly by the example described herein, it will be apparent to those skilled in the art that various alterations, modifications and other changes may be made without departing from the spirit and scope of the present invention. It is therefore intended that all such modifications, alterations and other changes be encompassed by the claims.

1. A sensitive surface protective material for protecting a sensitive surface of an article comprising a nonwoven web having a bulk density in the range of about 0.075 g/cc to about 0.130 g/cc, a Gurley stiffness greater than about 80 mg and voids within the nonwoven web structure capable of entrapping particles, wherein the sensitive surface protective material protects the sensitive surface from damage caused by particles.

2. The sensitive surface protective material of claim 1, wherein the nonwoven web comprises a through-air bonded nonwoven web comprising multicomponent spunbond filaments.

3. The sensitive surface protective material of claim 2, wherein the multicomponent filaments are bicomponent filaments comprising a first polymer component and a second polymer component.

4. The sensitive surface protective material of claim 3, wherein the first polymer component comprises polyethylene and the second polymer component comprises polypropylene.

5. The sensitive surface protective material of claim 4, wherein the first polymer component and the second polymer component are arranged in a side-by-side configuration.

6. The sensitive surface protective material of claim 4, wherein the multicomponent filaments comprise a sheath/core configuration and the sheath comprises the first polymer component and the core comprises the second polymer component.

7. The sensitive surface protective material of claim 1, wherein the bulk density is between about 0.08 g/cc and about 0.125 g/cc and the Gurley stiffness is at least about 100 mg.

8. The sensitive surface protective material of claim 7, wherein the bulk density is between about 0.09 g/cc and about 0.120 g/cc.

9. The sensitive surface protective material of claim 8, wherein the nonwoven web comprises a through-air bonded spunbond nonwoven web comprising side-by-side bicomponent fibers comprising, as a first component, polyethylene, and, as a second component, polypropylene.

10. The sensitive surface protective material of claim 8, wherein the nonwoven web comprises a spunbond nonwoven web comprising side-by-side bicomponent filaments comprising, as a first component, polyethylene, and, as a second component, polypropylene, and wherein the spunbond nonwoven web is bonded with a pattern having a continuous bonded areas defining a plurality of discrete unbonded areas.

11. The sensitive surface protective material of claim 1, wherein the nonwoven web comprises multicomponent spunbond filaments bonded in a pattern having a continuous bonded areas defining a plurality of discrete unbonded areas.

12. The sensitive surface protective material of claim 11, wherein the multicomponent filaments are bicomponent filaments comprising a first polymer component and a second polymer component.

13. The sensitive surface protective material of claim 12, wherein the first polymer component comprises polyethylene and the second polymer component comprises polypropylene.

14. The sensitive surface protective material of claim 13, wherein the first polymer component and the second polymer component are arranged in a side-by-side configuration.

15. The sensitive surface protective material of claim 13, wherein the multicomponent filaments comprise a sheath/core configuration and the sheath comprises the first polymer component and the core comprises the second polymer component.

16. A storage sleeve comprising the sensitive surface protective material of claim 1.

17. A storage sleeve for holding an article having a sensitive surface to protect the sensitive surface from damage comprising
a first web having a top edge, a bottom edge and two side edges and
a second web comprising a nonwoven web having a bulk density in the range of about 0.075 g/cc to about 0.130 g/cc and a Gurley stiffness greater than about 80 mg and having a top edge, a bottom edge and two side edges,
wherein the first web is interconnected with the second web at or near the bottom edge and two side edges of the first web to form a pocket to hold said article having a sensitive surface.

18. The storage sleeve according to claim 17, wherein the first web comprises a nonwoven web having a bulk density in the range of about 0.08 g/cc to about 0.125 g/cc and a Gurley stiffness greater than about 100 mg.

19. The storage sleeve according to claim 17, wherein the first web comprises a film.

20. The storage sleeve according to claim 19, wherein the film comprises a polyolefin selected from the group consisting of polyethylene and polypropylene.

21. The storage sleeve according to claim 17, further comprising a third web having a top edge, a bottom edge and two side edges,
wherein the second web is positioned between the first web and the third web and the first web and the third web are interconnected with the second web at or near the bottom edge and the two side edges of the first web and the third web to form a pocket to hold an article having a sensitive surface on each side of the second web.

22. The storage sleeve according to claim 21, wherein the first web and the third web comprise a film.

23. The storage sleeve according to claim 22, wherein the film comprises a polyolefin selected from the group consisting of polyethylene and polypropylene.

24. The storage sleeve according to claim 17, wherein the nonwoven web is a through-air bonded nonwoven web of multicomponent spunbond filaments.

25. The storage sleeve according to claim 24, wherein the multicomponent filaments are bicomponent filaments comprising a first polymer component and a second polymer component.

26. The storage sleeve according to claim 25, wherein the first polymer component is polyethylene and the second polymer component is polypropylene.

27. The storage sleeve according to claim 26, wherein the first polymer component and the second polymer component are arranged in a side-by-side configuration.

28. The storage sleeve according to claim 25, wherein the multicomponent filaments comprise a sheath/core configuration and the sheath comprises the first polymer component and the core comprises the second polymer component.

29. The storage sleeve according to claim 17, wherein the nonwoven web comprises multicomponent spunbond filaments bonded in a pattern having a continuous bonded areas defining a plurality of discrete unbonded areas.

30. The storage sleeve according to claim 29, wherein the multicomponent filaments are bicomponent filaments comprising a first polymer component and a second polymer component.

31. The storage sleeve according to claim 30, wherein the first polymer component is polyethylene and the second polymer component is polypropylene.

32. The storage sleeve according to claim 31, wherein the first polymer component and the second polymer component are arranged in a side-by-side configuration.

33. The storage sleeve according to claim 31, wherein the multicomponent filaments comprise a sheath/core configuration and the sheath comprises the first polymer component and the core comprises the second polymer component.

34. The storage sleeve according to claim 21, wherein the nonwoven web is a through-air bonded nonwoven web of multicomponent filaments.

35. The storage sleeve according to claim 34, wherein the multicomponent filaments are bicomponent filaments comprising a first polymer component and a second polymer component.

36. The storage sleeve according to claim 35, wherein the first polymer component is polyethylene and the second polymer component is polypropylene.

37. The storage sleeve according to claim 36, wherein the first polymer component and the second polymer component are arranged is a side-by-side configuration.

38. The storage sleeve according to claim 36, wherein the multicomponent filaments comprise a sheath/core configuration and the sheath comprises the first polymer component and the core comprises the second polymer component.

39. The storage sleeve according to claim 37, wherein the first and third webs are films.

40. The storage sleeve according to claim 38, wherein the first and third webs are films.

41. The storage sleeve according to claim 39, wherein the film comprises a polyolefin selected from the group consisting of polyethylene and polypropylene.

42. The storage sleeve according to claim 40, wherein the film comprises a polyolefin selected from the group consisting of polyethylene and polypropylene.

43. The storage sleeve according to claim 41, wherein the film comprises polyethylene.

44. The storage sleeve according to claim 42, wherein the film comprises polyethylene.

45. The storage sleeve according to claim 21, wherein the nonwoven web comprises multicomponent spunbond filaments bonded in a pattern having a continuous bonded areas defining a plurality of discrete unbonded areas.

46. A method of protecting a sensitive surface comprising contacting the sensitive surface with the sensitive surface protecting material of claim 1.

47. A stack of articles having a sensitive surface, comprising a plurality of articles having at least one sensitive surface and a sensitive surface protecting material between each article in the stack, wherein the sensitive surface protecting material comprises the sensitive surface protecting material of claim 1.
